(19) United States
(12) Patent Application Publication
(10) Pub. No.: US 2026/0236976 A1
(43) Pub. Date: Aug. 13, 2026

(54) METHOD AND SYSTEM FOR COST OF CARE PREDICTION BASED DYNAMIC INSURANCE PLAN RECOMMENDATION AND PRICING

(71) Applicant: Tata Consultancy Services Limited, Mumbai (IN)

(72) Inventors: Rajat Subhra PAL, Kolkata (IN); Avik GHOSE, Kolkata (IN); Sakyajit BHATTACHARYA, Kolkata (IN); Avishek HALDER, Kolkata (IN); Subhadeep MONDAL, Kolkata (IN)

(73) Assignee: Tata Consultancy Services Limited, Mumbai (IN)

(21) Appl. No.: 19/247,192

(22) Filed: Jun. 24, 2025

(30) Foreign Application Priority Data
Feb. 13, 2025 (IN) 202521012225

(51) Int. Cl. G06Q 30/0601; G06Q 30/0201; G06Q 40/08

(52) U.S. Cl. CPC G06Q 30/0631; G06Q 30/0206; G06Q 40/08

(57) ABSTRACT

Group insurance plan recommendation is a challenging task, since the conventional methods fail to predict the cost of care. The present disclosure dynamically recommends group insurance plans based on cost of care prediction. The present disclosure segments the cleaned input data of beneficiaries and generates personas. Further, risk scores are computed and the personas are categorized into risk tiers. Further, a correlation and an association is computed between a plurality of disorders using market basket analysis. A ranked list of insurance plans are generated, and a plurality of common features are identified. Further, a plurality of potential insurance plans are determined from the top ranked insurance plans. Further, real time pricing points are computed for the potential insurance plans. Finally, an optimal insurance plan is recommended from among the plurality of potential insurance plans for each of the plurality personas based on the computed real time pricing points.

### PRIORITY CLAIM

This U.S. patent application claims priority under 35 U.S.C. § 119 to: Indian Patent Application No. 202521012225, filed on Feb. 13, 2025. The entire contents of the aforementioned application are incorporated herein by reference.

### TECHNICAL FIELD

The disclosure herein generally relates to the field of machine learning and, more particularly, to a method and system for cost of care prediction based dynamic insurance plan recommendation and pricing.

### BACKGROUND

In healthcare, a payor is a person, organization, or entity that pays for the care services administered by a healthcare provider. In the current insurance landscape, payers often face significant delays and challenges when onboarding employer groups and setting up customized insurance plans. This results in payer businesses taking about 3-5 years to recover costs and become profitable for any specific group. This inefficiency is primarily due to the difficulty in underwriting and pricing based on individual risks within an employer group. Moreover, the traditional methods of offering a limited number of static plans do not account for the diverse needs of employees, leading to potential dissatisfaction and high attrition rates. This challenge extends across various types of coverage, including medical, prescription drugs, specialty pharmaceuticals, dental, and vision insurance.

One conventional approach accepts as input the existing health condition of a person and recommends to that person a health insurance plan, from an existing set of plans, with an associated cost. In this case, the cost of existing condition is taken into account through probable costs of drug, physician, and care. This is achieved via a set of rules associated with the reported condition. Another approach pertains to the generation of on-demand insurance policy for a trip based on contextual risk and driving profile. A risk-score is calculated for a given mode of transport and a given trip. While the prior art does compute a dynamic risk score for generating insurance policy, the domain demands a risk based on history and context. Another conventional approach solves a set of systems of Hamiltonian-Jacobi-Bellman (HJB) equations to come up with a Nash equilibrium to maximize the expected terminal and exponential utilities. While the closed-form solution exists for general insurance, human health depends upon a large number of parameters and hence empirical methods are needed based on demographics and morbidity. However, no conventional approaches are predicting cost of care for employer groups or group insurance plans.

### SUMMARY

Embodiments of the present disclosure present technological improvements as solutions to one or more of the above-mentioned technical problems recognized by the inventors in conventional systems. For example, in one embodiment, a method for cost of care prediction based dynamic insurance plan recommendation and pricing is provided. The method includes receiving, by one or more hardware processors, an input data pertaining to a plurality of beneficiaries, wherein the input data comprises a demographic data, a historical claims data, an insurance plan survey, a cost per beneficiary, a total claim amount vs time, disease severity, and utilization patterns. Further, the method includes generating, by the one or more hardware processors, a clean data by performing data cleaning and data validation on the input data, wherein the data cleaning and the data validation process comprises identifying and filling missing values, identifying and correcting inconsistent data, and datatype conversion. Furthermore, the method includes segmenting, by the one or more hardware processors, the plurality of beneficiaries into a plurality of groups based on the clean data, wherein the plurality of groups comprises a disease prevalence, an age vs disease propensity, and a preventive healthcare data. Furthermore, the method includes generating, by the one or more hardware processors, a plurality of personas with distinct profiles based on the segmented plurality of groups, wherein each of the plurality of personas comprises a plurality of coverage types, a plurality of critical features, and a plurality of additional features. Furthermore, the method includes computing, by the one or more hardware processors, a plurality of risk scores for each of the plurality of personas based on a cost of care associated with each of the plurality of personas, a healthcare utilization frequency associated with each of the plurality of personas, and an associated disease risk, using a weight based risk computation technique. Furthermore, the method includes categorizing, by the one or more hardware processors, the plurality of personas into a plurality of risk tiers based on the computed plurality of risk scores, wherein the plurality of risk tiers comprises low risk, medium risk and high risk groups based on associated range of risk thresholds. Furthermore, the method includes identifying, by the one or more hardware processors, a correlation and an association between a plurality of disorders to have simultaneous occurrence in the portfolio of each of the plurality of beneficiaries based on the categorized plurality of personas using a market basket analysis. Furthermore, the method includes generating, by the one or more hardware processors, a ranked list of insurance plans for each of the plurality personas based on the identified correlation and the association between the plurality of disorders, using one or more rank based matching algorithms. Furthermore, the method includes identifying, by the one or more hardware processors, a plurality of common features associated with each of a plurality of top ranked insurance plans from among the ranked list of insurance plans for each of the plurality of personas. Furthermore, the method includes identifying, by the one or more hardware processors, the plurality of coverage types and benefits associated with the plurality of top ranked insurance plans based on the identified plurality of common features. Furthermore, the method includes determining, by the one or more hardware processors, a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique. Furthermore, the method includes computing, by the one or more hardware processors, real time pricing points for each of the plurality of potential insurance plans based on an associated plurality of historical claim frequency and a historical reimbursement pattern, using a dynamic pricing model. Finally, the method includes recommending, by the one or more hardware processors, an optimal insurance plan from among the plurality of potential insurance plans for each of the plurality personas based on the computed real time pricing points, using a recommendation technique.

In another aspect, a system for cost of care prediction based dynamic insurance plan recommendation and pricing is provided. The system includes at least one memory storing programmed instructions, one or more Input/Output (I/O) interfaces, and one or more hardware processors operatively coupled to the at least one memory, wherein the one or more hardware processors are configured by the programmed instructions to receive an input data pertaining to a plurality of beneficiaries, wherein the input data comprises a demographic data, a historical claims data, an insurance plan survey, a cost per beneficiary, a total claim amount vs time, disease severity, and utilization patterns. Further, the one or more hardware processors are configured by the programmed instructions to generate a clean data by performing data cleaning and data validation on the input data, wherein the data cleaning and the data validation process comprises identifying and filling missing values, identifying and correcting inconsistent data, and datatype conversion. Furthermore, the one or more hardware processors are configured by the programmed instructions to segment the plurality of beneficiaries into a plurality of groups based on the clean data, wherein the plurality of groups comprises a disease prevalence, an age vs disease propensity, and a preventive healthcare data. Furthermore, the one or more hardware processors are configured by the programmed instructions to generate a plurality of personas with distinct profiles based on the segmented plurality of groups, wherein each of the plurality of personas comprises a plurality of coverage types, a plurality of critical features, and a plurality of additional features. Furthermore, the one or more hardware processors are configured by the programmed instructions to compute a plurality of risk scores for each of the plurality of personas based on a cost of care associated with each of the plurality of personas, a healthcare utilization frequency associated with each of the plurality of personas, and an associated disease risk, using a weight based risk computation technique. Furthermore, the one or more hardware processors are configured by the programmed instructions to categorize the plurality of personas into a plurality of risk tiers based on the computed plurality of risk scores, wherein the plurality of risk tiers comprises low risk, medium risk and high risk groups based on associated range of risk thresholds. Furthermore, the one or more hardware processors are configured by the programmed instructions to identify a correlation and an association between a plurality of disorders to have simultaneous occurrence in the portfolio of each of the plurality of beneficiaries based on the categorized plurality of personas using a market basket analysis. Furthermore, the one or more hardware processors are configured by the programmed instructions to generate a ranked list of insurance plans for each of the plurality personas based on the identified correlation and the association between the plurality of disorders, using one or more rank based matching algorithms. Furthermore, the one or more hardware processors are configured by the programmed instructions to identify a plurality of common features associated with each of a plurality of top ranked insurance plans from among the ranked list of insurance plans for each of the plurality of personas. Furthermore, the one or more hardware processors are configured by the programmed instructions to identify the plurality of coverage types and benefits associated with the plurality of top ranked insurance plans based on the identified plurality of common features. Furthermore, the one or more hardware processors are configured by the programmed instructions to determine a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique. Furthermore, the one or more hardware processors are configured by the programmed instructions to compute real time pricing points for each of the plurality of potential insurance plans based on an associated plurality of historical claim frequency and a historical reimbursement pattern, using a dynamic pricing model. Finally, the one or more hardware processors are configured by the programmed instructions to recommend an optimal insurance plan from among the plurality of potential insurance plans for each of the plurality personas based on the computed real time pricing points, using a recommendation technique.

In yet another aspect, a computer program product including a non-transitory computer-readable medium embodied therein a computer program for cost of care prediction based dynamic insurance plan recommendation and pricing is provided. The computer readable program, when executed on a computing device, causes the computing device to receive an input data pertaining to a plurality of beneficiaries, wherein the input data comprises a demographic data, a historical claims data, an insurance plan survey, a cost per beneficiary, a total claim amount vs time, disease severity, and utilization patterns. Further, the computer readable program, when executed on a computing device, causes the computing device to generate a clean data by performing data cleaning and data validation on the input data, wherein the data cleaning and the data validation process comprises identifying and filling missing values, identifying and correcting inconsistent data, and datatype conversion. Furthermore, the computer readable program, when executed on a computing device, causes the computing device to segment the plurality of beneficiaries into a plurality of groups based on the clean data, wherein the plurality of groups comprises a disease prevalence, an age vs disease propensity, and a preventive healthcare data. Furthermore, the computer readable program, when executed on a computing device, causes the computing device to generate a plurality of personas with distinct profiles based on the segmented plurality of groups, wherein each of the plurality of personas comprises a plurality of coverage types, a plurality of critical features, and a plurality of additional features. Furthermore, the computer readable program, when executed on a computing device, causes the computing device to compute a plurality of risk scores for each of the plurality of personas based on a cost of care associated with each of the plurality of personas, a healthcare utilization frequency associated with each of the plurality of personas, and an associated disease risk, using a weight based risk computation technique. Furthermore, the computer readable program, when executed on a computing device, causes the computing device to categorize the plurality of personas into a plurality of risk tiers based on the computed plurality of risk scores, wherein the plurality of risk tiers comprises low risk, medium risk and high risk groups based on associated range of risk thresholds. Furthermore, the computer readable program, when executed on a computing device, causes the computing device to identify a correlation and an association between a plurality of disorders to have simultaneous occurrence in the portfolio of each of the plurality of beneficiaries based on the categorized plurality of personas using a market basket analysis. Furthermore, the computer readable program, when executed on a computing device, causes the computing device to generate a ranked list of insurance plans for each of the plurality personas based on the identified correlation and the association between the plurality of disorders, using one or more rank based matching algorithms. Furthermore, the computer readable program, when executed on a computing device, causes the computing device to identify a plurality of common features associated with each of a plurality of top ranked insurance plans from among the ranked list of insurance plans for each of the plurality of personas. Furthermore, computer readable program, when executed on a computing device, causes the computing device to identify the plurality of coverage types and benefits associated with the plurality of top ranked insurance plans based on the identified plurality of common features. Furthermore, the computer readable program, when executed on a computing device, causes the computing device to determine a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique. Furthermore, the computer readable program, when executed on a computing device, causes the computing device to real time pricing points for each of the plurality of potential insurance plans based on an associated plurality of historical claim frequency and a historical reimbursement pattern, using a dynamic pricing model. Finally, the computer readable program, when executed on a computing device, causes the computing device to recommend an optimal insurance plan from among the plurality of potential insurance plans for each of the plurality personas based on the computed real time pricing points, using a recommendation technique.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system for cost of care prediction based dynamic insurance plan recommendation and pricing, in accordance with some embodiments of the present disclosure.

FIG. 1B illustrates overall functional architecture of the system for the cost of care prediction based dynamic insurance plan recommendation and pricing, in accordance with some embodiments of the present disclosure.

FIG. 2A, FIG. 2B and FIG. 2C (collectively referred to as FIG. 2) illustrate a flow diagram for a processor implemented method for cost of care prediction based dynamic insurance plan recommendation and pricing, in accordance with some embodiments of the present disclosure.

FIGS. 3A and 3B illustrate plots for recurrent diseases for certain age group of male and female subjects, in accordance with some embodiments of the present disclosure.

FIG. 3C illustrates an example output of Market Basket Analysis (MBA), in accordance with some embodiments of the present disclosure.

FIG. 4 indicates the prediction (based on age gender and disease prevalence) of the claim amount over a period of years, in accordance with some embodiments of the present disclosure

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Cost of Care refers to the financial expenditure required to provide care services to individuals, particularly those who need assistance due to age, disability, or health conditions. In a typical scenario, payer businesses take about 3-5 years to recover costs and become profitable for any specific group business. This could be due to a two-fold reasons: (i) Lack of sufficient insights from the available data, and (ii) Limited abilities of the existing legacy systems will be able to support with quick rollout of new health insurance plans. This inability to predict cost of care customized for employer groups is due to technological and resource constraints and the lengthy onboarding process for employer groups.

Lack of sufficient insights: The systems supporting health insurance plans are often not adequately equipped to provide critical insights. These insights are pertinent to several factors that influence the success and efficacy of the health insurance plans. Factors such as group attrition rates, patterns based on group factors like denial rates, and the ratio of claims per member are crucial for understanding and improving operations. However, these systems often fall short in providing such valuable information. This lack of sufficient insights is a significant drawback, as it hampers the ability to make informed decisions, optimize processes, and enhance overall performance. Without these insights, it is challenging to predict potential risks, identify opportunities for improvement, and strategize effectively.

As mentioned above, because of this inability of payers to underwrite and price employer group insurance plans effectively based on the individual risks of employees. This limitation results in a handful of generic plans being offered, which may not adequately meet the diverse needs of the employee population. Consequently, this can lead to suboptimal plan performance and employee dissatisfaction. Furthermore, the onboarding process for employer groups is cumbersome, taking approximately 45-50 days due to the complexity of setting up benefit plans, testing plan configurations, and establishing premium billing schedules. The present disclosure aims to overcome the following challenges: (i) the inability to predict cost of care customized for employer groups due to technological and resource constraints and (ii) the lengthy onboarding process for employer groups.

To overcome the said challenges, embodiments herein provide a method and system for cost of care prediction based dynamic insurance plan recommendation and pricing. The objective of the present disclosure is to come up with a Machine Learning (ML) based model which can help to predict how such a product can be designed to help insurance companies reach early breakeven. The primary issue addressed by the present disclosure is the inability of payers to underwrite and price employer group insurance plans effectively based on the individual risks of employees.

The present disclosure receives an input data pertaining to a plurality of beneficiaries. Further, clean data is generated by performing data cleaning and data validation on the input data. A plurality of beneficiaries are segmented further into a plurality of groups based on the generated clean data, a disease prevalence, an age-disease propensity and a preventive healthcare. Post segmentation, a plurality of personas are generated with distinct employee profiles based on the segmented plurality of groups, wherein each of the plurality of personas comprises a plurality of coverage types, a plurality of critical features, and a plurality of additional features. Post generating personas, a plurality of risk scores are computed for each of the plurality of personas based on a cost of care associated with each of the plurality of personas, a healthcare utilization frequency associated with each of the plurality of personas, and an associated disease risk, using a weight-based risk computation technique. Post computing the plurality of risk scores, the plurality of personas are categorized into a plurality of risk tiers based on the computed plurality of risk scores, wherein the plurality of risk tiers comprises low risk, medium risk and high-risk groups. Post categorizing the plurality of personas, a correlation and an association is computed between a plurality of disorders to have simultaneous occurrence in the portfolio of each of the plurality of beneficiaries based on the categorized plurality of personas using market basket analysis. Further, a ranked list of insurance plans is generated for each of the plurality personas based on the identified correlation and the association between the plurality of disorders using rank based matching algorithms. Furthermore, a plurality of common features associated with each of a plurality of top ranked insurance plans are identified from among the ranked list of insurance plans for each of the plurality of personas. Post identifying the common features, the plurality of coverage types and benefits associated with the plurality of top ranked insurance plans are identified based on the identified plurality of common features. Post identification of top ranked insurance plans, a plurality of optimal insurance plans are determined from among the plurality of top ranked insurance, for each of the plurality of personas. Furthermore, real time pricing points are computed for each of the plurality of optimal insurance plans based on an associated plurality of historical claim frequency and historical reimbursement pattern using a dynamic pricing model. Finally, an optimal insurance plan is recommended from among the plurality of optimal insurance plans for each of the plurality personas based on the computed real time pricing points.

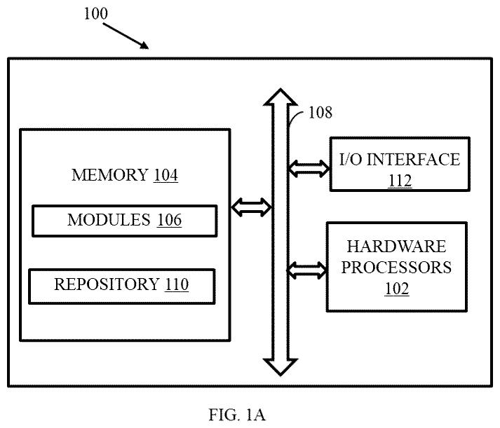

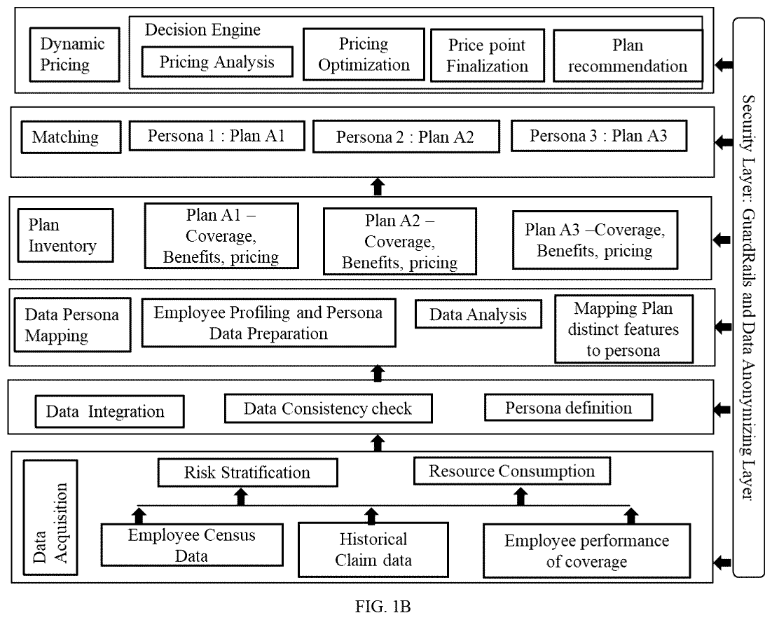

Referring now to the drawings, more particularly to FIG. 1A through FIG. 4, where similar reference characters denote corresponding features consistently throughout the figures, there are shown preferred embodiments, and these embodiments are described in the context of the following exemplary system and/or method.

FIG. 1A is a functional block diagram of system 100 for cost of care prediction based dynamic insurance plan recommendation and pricing, in accordance with some embodiments of the present disclosure. The system 100 includes or is otherwise in communication with hardware processors 102, at least one memory such as a memory 104, an Input/Output (I/O) interface 112. The hardware processors 102, memory 104, and the I/O interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in memory 104.

The memory 104 may include any computer-readable medium known in the art including, for example, volatile memory, such as static random-access memory (SRAM) and Dynamic Random Access Memory (DRAM), and/or non-volatile memory, such as read only memory (ROM), erasable programmable ROM, flash memories, hard disks, optical disks, and magnetic tapes. In an embodiment, memory 104 includes a plurality of modules 106. Memory 104 also includes a data repository (or repository) 110 for storing data processed, received, and generated by the plurality of modules 106.

The plurality of modules 106 includes programs or coded instructions that supplement applications or functions performed by the system 100 for Cost of care prediction based dynamic insurance plan recommendation and pricing. The plurality of modules 106, amongst other things, can include routines, programs, objects, components, and data structures, which perform particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for Cost of care prediction based dynamic insurance plan recommendation and pricing.

The data repository (or repository) 110 may include a plurality of abstracted pieces of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such an external database may be periodically updated. For example, new data may be added into the database (not shown in FIG. 1A) and/or existing data may be modified and/or non-useful data may be deleted from the database. In one example, the data may be stored in an external system, such as a Lightweight Directory Access Protocol (LDAP) directory, a Relational Database Management System (RDBMS).

The overall architecture of the system of FIG. 1A is explained in conjunction with FIG. 1B.

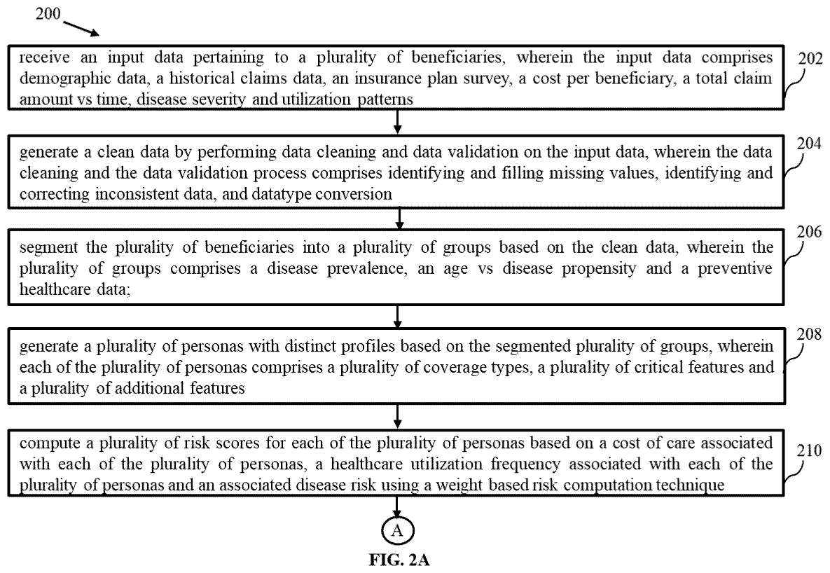

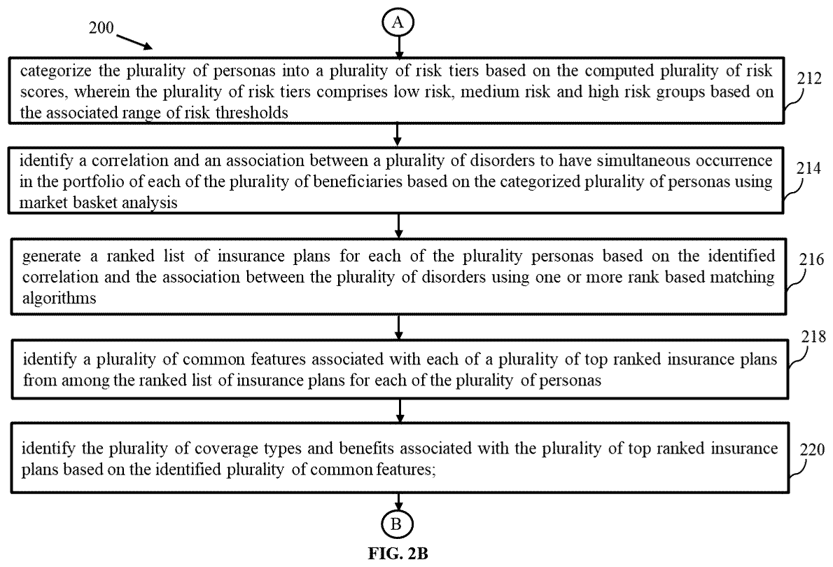

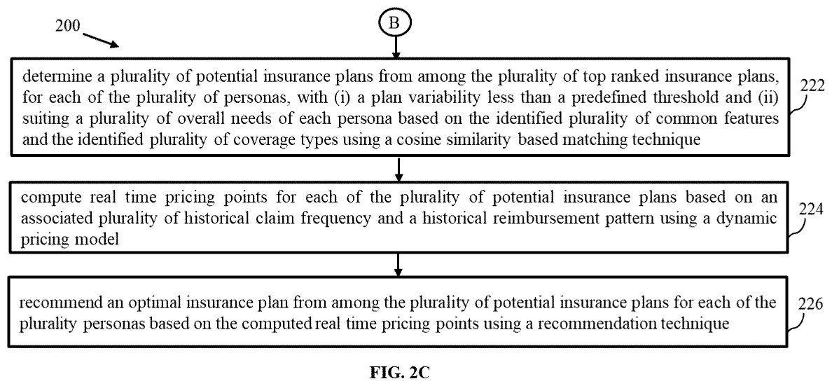

The working of the components of system 100 are explained with reference to the method steps depicted in FIG. 2.

FIGS. 2A, 2B and 2C (collectively referred to as FIG. 2) is an exemplary flow diagram illustrating a method 200 for cost of care prediction based dynamic insurance plan recommendation and pricing implemented by the system of FIGS. 1A and 1B, according to some embodiments of the present disclosure. In an embodiment, the system 100 includes one or more data storage devices or the memory 104 operatively coupled to the one or more hardware processor(s) 102 and is configured to store instructions for execution of steps of the method 200 by the one or more hardware processors 102. The steps of method 200 of the present disclosure will now be explained with reference to the components or blocks of system 100 as depicted in FIGS. 1A and 1B and the steps of flow diagram as depicted in FIG. 2. The method 200 may be described in the general context of computer executable instructions. Generally, computer executable instructions can include routines, programs, objects, components, data structures, procedures, modules, functions, etc., that perform particular functions or implement particular abstract data types.

The method 200 may also be practiced in a distributed computing environment where functions are performed by remote processing devices that are linked through a communication network. The order in which steps of the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

Now referring to FIG. 2, at step 202 of method 200, the one or more hardware processors 102 are configured by the programmed instructions to receive an input data pertaining to a plurality of beneficiaries, wherein the input data includes demographic data, a historical claims data, an insurance plan survey, a cost per beneficiary, a total claim amount vs time, disease severity and utilization patterns. The cost per beneficiary includes costs of drug, physician, and care. The historical claims data includes medical treatments, prescription usage, specialty pharmaceuticals, and other health-related expenses, incurred by the beneficiary in the past medical history. This data provides insights into the risk stratification and resource consumption of employees.

At step 204 of the method 200, the one or more hardware processors 102 are configured by the programmed instructions to generate a clean data by performing data cleaning and data validation on the input data. The data cleaning and the data validation process includes identifying and correcting missing values, identifying inconsistent data, and datatype conversion using standard techniques.

At step 206 of the method 200, the one or more hardware processors 102 are configured by the programmed instructions to segment the plurality of beneficiaries into a plurality of groups based on the clean data. The plurality of groups includes a disease prevalence, an age vs disease propensity and a preventive healthcare.

For example, the disease prevalence of a subject (or beneficiary or patient) is calculated as follows: Let the age groups be defined as A₁, A₂ and A₃ etc. and the gender be classified as M and F. For a certain disease D, the prevalence rates are defined as pₐᵢ=P(D|Aᵢ), p₁=P(D|M) and p₂=P(D|F). Then, for a male falling in the age group Aᵢ, the prevalence rate will be p=P(D|(Aᵢ∩M)). p can be estimated as below:

$$\begin{matrix}p = P ( D \vert {A}_{i} ∩ M ) \\ = \frac{P ( {A}_{i} \vert D ) P ( M \vert D ) P ( D )}{P ( {A}_{i} ) P ( M )} \\ = \frac{P ( D \vert {A}_{i} ) P ( D \vert M )}{P ( D )} \\ = \frac{{P}_{ai} {P}_{1}}{P ( D )}\end{matrix} \qquad ( 1 )$$

Since age and gender are two independent variables, the denominator can be estimated as ΣᵢP(D|Aᵢ)P(Aᵢ)=ΣᵢpᵢₐP(Aᵢ) where P(Aᵢ) can be found from standard literature. Similar calculation follows for a female subject. Now, a subject can have ‘n’ number of complications which, in a composite manner, lead to a cost C. For a certain age-group Aᵢ, the cost is calculated of all such subjects. Suppose for the j^{th} patient in a certain year q, the n complications incur a total cost of C_{jq}. Then the cost could be broken in three factors (i) Recurring cost: Costs that recur over the years due to some existing disease (ii) Spiked cost: Cost that happens due to some new disease and (iii) Probable cost: Cost that did not yet happen, but can happen in the future years due to prevalent diseases in the age and gender category. This has to be calculated based on the market basket analysis.

If in a year q, there is a spike in the claim, a new disease that may have caused the spike may be looked at and the related cost can be found by subtracting the past years mean claim amount from the claim amount of year q. Then, the age and gender-based prevalence rate related to that certain disease could be found. Also, for the third component, the prevalence rate of top five (or ten diseases) for that gender and age category could be found (by ranking the p values calculated as above and taking the highest five or ten).

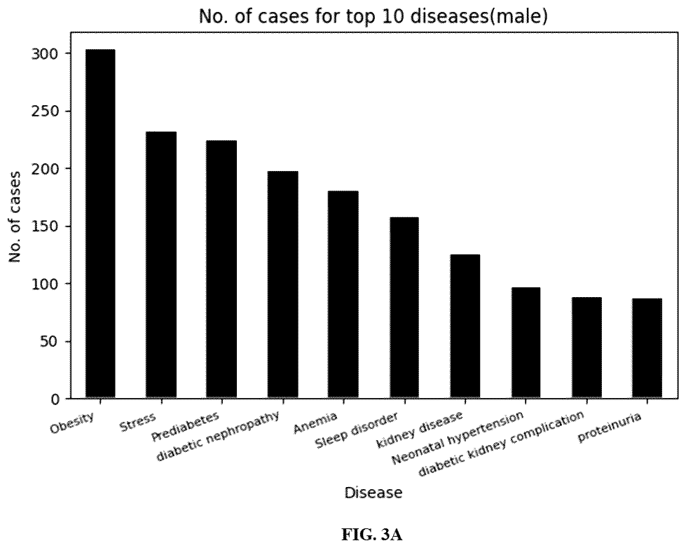

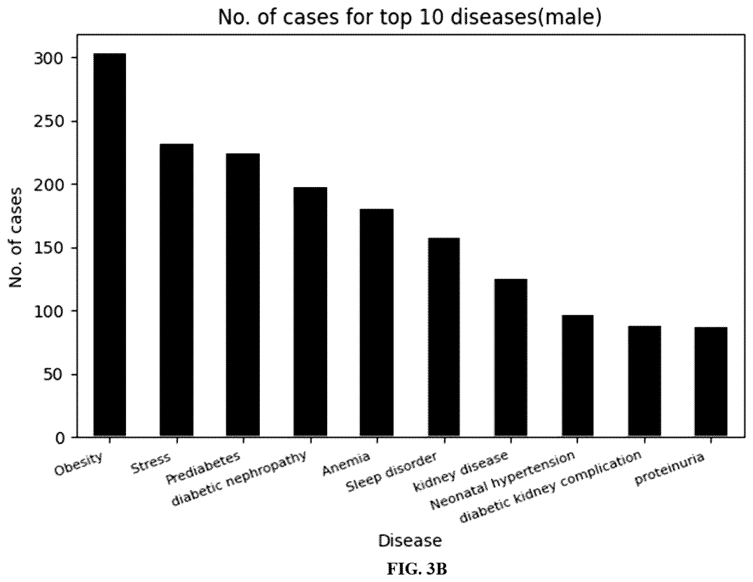

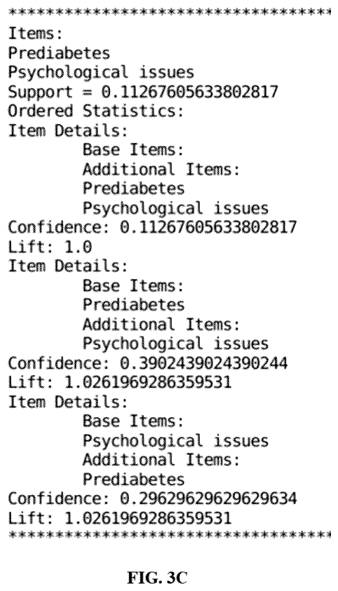

FIG. 3A and FIG. 3B illustrates most recurrent diseases for age group (45, 64) for both male and female subjects accordingly.

Now, referring back to FIG. 2, at step 208 of the method 200, the one or more hardware processors 102 are configured by the programmed instructions to generate a plurality of personas with distinct employee profiles based on the segmented plurality of groups. Each of the plurality of personas includes a plurality of coverage types, a plurality of critical features and a plurality of additional features. The plurality of coverage types includes medical, dental and vision. The plurality of critical features includes high coverage limits and low out-of-pocket costs. The plurality of additional features includes wellness programs, telemedicine access and alternative medicine coverage. An example persona representing a segment of population likely to be part of an employer-sponsored health insurance group is shown in Table I.

TABLE I

| Features | Description | Rationale (Connecting to Data & Problem) |
|---|---|---|
| Name: | XXXX | Representative name for demographics |
| Age: | 48 | Falls within the 45-64 age range, a key |
| | | demographic for group insurance and a |
| | | focus of the provided data analysis. This |
| | | age group is approaching higher |
| | | healthcare utilization years. |
| Gender: | Female | Allows for application of gender-specific |
| | | prevalence data (e.g., higher rates of |
| | | prediabetes, anemia in females per FIG. 3B). |
| Location: | XXXX | Represents a common US employment |
| | XXXX | hub, allowing for potential location-based |
| | | cost variations in healthcare. |
| Occupation: | Project | Mid-career professional, suggesting a |
| | Manager | stable income and employer-sponsored |
| | | insurance likelihood. |
| Family | Married, 2 | Implies potential family coverage needs |
| Status: | children (10, | and higher utilization of pediatric/family |
| | 14) | services. |
| Health | Prediabetes, history | Aligns with prevalent conditions identified |
| Concerns: | of anemia, concerned | in the sample data (FIG. 3B) and |
| | about family history | emphasizes preventative care needs. This |
| | of heart disease. | drives the need for specific coverage types |
| | | and benefits. |
| Insurance | Affordable premiums, | Balances cost sensitivity with the need for |
| Priorities: | good coverage for | comprehensive coverage related to |
| | preventative care | existing and potential future health |
| | (e.g., annual checkups, | concerns. Directly addresses the problem |
| | blood tests), coverage | of generic plans not meeting diverse |
| | for specialist visits | needs. |
| | (cardiologist). | |
| | Low out-of-pocket | |
| | maximum. | |
| Tech | Moderate | Comfortable using online portals and |
| Savviness: | | telemedicine, but might need some |
| | | guidance with complex insurance features. |

At step 210 of the method 200, the one or more hardware processors 102 are configured by the programmed instructions to compute a plurality of risk scores for each of the plurality of personas based on a cost of care associated with each of the plurality of personas, a healthcare utilization frequency associated with each of the plurality of personas and an associated disease risk using a weight based risk computation technique. For example, the weight based risk computation technique assigns weights to corresponding factors of diseases (i.e. prevalent diseases getting more weights) and then adds all of them to get a meta-view of the risk. The weights are derived either by statistical methods like cross-validation or from the medical domain as shown in Table II.

TABLE II

| | | | | Value (for a | |
|---|---|---|---|---|---|
| | | Data | | hypothetical | Weighted |
| Factor | Description | Source | Weight | individual) | Score |
| Age | Age of the | Employee | 0.25 | 55 (Age | 13.75 |
| | beneficiary. | Census | | group 45-64) | |
| Gender | Gender of the | Employee | 0.10 | Male | 1 |
| | beneficiary. | Census | | | |
| Pre- | Presence and | Claim | 0.30 | Prediabetes, | 9 |
| existing | severity of | History | | Obesity | |
| Conditions | pre-existing | | | | |
| | conditions | | | | |
| | (e.g., diabetes, | | | | |
| | heart disease). | | | | |
| Healthcare | Frequency of | Claim | 0.15 | Moderate | 2.25 |
| Utilization | doctor visits, | History | | utilization | |
| | hospitalizations, | | | | |
| | etc. | | | | |
| Preventive | Engagement | Claim | 0.10 | Low | 1 |
| Care | in preventive | History/ | | engagement | |
| | care activities | Survey | | | |
| | (e.g., annual | | | | |
| | checkups, | | | | |
| | vaccinations). | | | | |
| Geographic | Cost of | Employee | 0.10 | Moderate | 1 |
| Location | healthcare in the | Census | | cost area | |
| | beneficiary's | | | | |
| | region. | | | | |
| Total | | | | | 28 |
| Weighted | | | | | |
| Risk | | | | | |
| Score | | | | | |

At step 212 of the method 200, the one or more hardware processors 102 are configured by the programmed instructions to categorize the plurality of personas into a plurality of risk tiers based on the computed plurality of risk scores, wherein the plurality of risk tiers includes low risk, medium risk and high risk groups based on associated range of risk thresholds. For example, risk depends on mainly age and past medical history. A person with higher age and significant medical history will fall in a high-risk group.

The following example utilizes a weighted scoring system based on factors relevant to healthcare costs. It demonstrates how individuals within an employer group could be categorized into risk tiers. Table III illustrates factors and weights associated with a beneficiary or subject.

TABLE III

| Factor | Description | Weight |
|---|---|---|
| Age | Age band (e.g., 18-30, 31-45, 46-60, 61+) | 20% |
| Chronic | Number and severity of pre-existing | 30% |
| Conditions | conditions (e.g., diabetes, heart disease, | |
| | cancer) | |
| Healthcare | Frequency of doctor visits, hospitalizations, | 25% |
| Utilization | emergency room visits in the past year | |
| Prescription | Number and cost of prescription medications | 15% |
| Drug Usage | taken regularly | |
| Lifestyle | Self-reported health status (e.g., smoker, | 10% |
| Factors | obese, sedentary lifestyle), preventive care | |
| | adherence | |

Now referring to Table III, each factor is assigned a score based on the individual's data. The scores are then multiplied by the corresponding weights and summed to calculate the total risk score. Some example scores are given in Table IV and the example risk score calculation is performed as:

$$Insurer A / Beneficiary A : ( 60 * 0.2 ) + ( 70 * 0.3 ) + ( 40 * 0.25 ) + ( 50 * 0.15 ) + ( 30 * 0.1 ) = 53.5 .$$

$$Insurer B / Beneficiary B : ( 25 * 0.2 ) + ( 10 * 0.3 ) + ( 20 * 0.25 ) + ( 0 * 0.15 ) + ( 80 * 0.1 ) = 21 .$$

Example Categorization: Beneficiary A: Medium Risk (Score: 53.5). Beneficiary B: Low Risk (Score: 21). This is a simplified example. A real-world implementation would likely involve more complex calculations. Some example risk tiers and corresponding description are shown in Table V.

TABLE IV

| | Score | Example | Example |
|---|---|---|---|
| Factor | Range | Beneficiary A | Beneficiary B |
| Age | 0-100 | 60 | 25 |
| Chronic Conditions | 0-100 | 70 | 10 |
| Healthcare Utilization | 0-100 | 40 | 20 |
| Prescription Drug Usage | 0-100 | 50 | 0 |
| Lifestyle Factors | 0-100 | 30 | 80 |

TABLE V

| Risk | | |
|---|---|---|
| Score | Risk | |
| Range | Tier | Description |
| 0-30 | Low | Individuals with a low probability of |
| | Risk | incurring high healthcare costs. |
| 31-60 | Medium | Individuals with a moderate probability of |
| | Risk | incurring high healthcare costs. |
| 61-100 | High | Individuals with a high probability of |
| | Risk | incurring high healthcare costs. |

At step 214 of the method 200, the one or more hardware processors 102 are configured by the programmed instructions to identify a correlation and an association between a plurality of disorders to have simultaneous occurrence in the portfolio of each of the plurality of beneficiaries based on the categorized plurality of personas using market basket analysis.

For example, correlation is not causation, however, is very valuable in certain circumstances. While underlying conditions like diabetes, hypertension, GI tract disorders etc., may all result from the underlying cause of obesity due to poor diet and exercise, but it still maybe important to know that a person having diabetes is also likely to have hypertension with a certain probability. Ideally, such computations are drawn from Bayesian methods with underlying models for causation. However, in the domain of healthcare, finding causal insights can be very difficult. However, from pure empirical analysis like the market-basket model, which works on co-occurrence of items in an item-set, actually provides a method to study empirical co-occurrence models for health conditions. Such models are useful in underwriting because they provide insights into the cost-of-care for near future. Here, it was shown that in a large data-set co-occurrence modeling using market-basket analysis (MBA), has provided us with “chance of getting disease Y, provided that the patient has disease X”. This is performed using empirical association rule mining.

In the present disclosure, the market basket analysis is performed to study which disease can cause which other disease, so that the occurrence of one disease can take into account the future occurrence of some other diseases with respective probabilities. An example output of MBA is shown in FIG. 3C. Here, Support is a measure that gives an idea of how frequent an item is in all the transactions. Confidence measures the likelihood of items given that the shopping cart already has other items. Lift controls for the support (frequency) while calculating the conditional probability of occurrence of Y given X.

Now referring back to FIG. 2A, at step 216 of the method 200, the one or more hardware processors 102 are configured by the programmed instructions to generate a ranked list of insurance plans for each of the plurality personas based on the identified correlation and the association between the plurality of disorders using rank based matching algorithms. The insurance plan survey includes types of coverage, desired features, and satisfaction with current plans. For example, the ranked list of insurance plans for a particular persona are shown in Table VI.

TABLE VI

| | | | | | Key Features | |
|---|---|---|---|---|---|---|
| | Plan Name | Premium | | Provider | Relevant to | Rationale |
| Rank | (Fictitious) | (Monthly) | Deductible | Network | Persona | for Ranking |
| 1 | “HealthGuard | $550 | $2,000 | Large, includes | Strong | Balances cost |
| | Plus” | | | preferred | preventative | with strong |
| | | | | endocrinologists | care coverage, | coverage for |
| | | | | and nutritionists | good diabetic | prediabetes |
| | | | | | medication | and obesity |
| | | | | | coverage on | management. |
| | | | | | formulary, | Wide network |
| | | | | | wellness | gives flexibility. |
| | | | | | program | |
| | | | | | discounts | |
| 2 | “MediCare | $480 | $3,500 | Medium, some | Lower | Good option for |
| | Advantage” | | | limitations on | premium, | cost-conscious |
| | | | | specialists | reasonable | individuals |
| | | | | | coverage | willing to |
| | | | | | for diabetic | accept higher |
| | | | | | supplies, some | deductible and |
| | | | | | telehealth | potential |
| | | | | | options | limitations on |
| | | | | | | specialist access. |
| 3 | “Blue Shield | $620 | $1,500 | Large, | Lowest | Best coverage |
| | Premier” | | | excellent | deductible, | but highest |
| | | | | specialist | comprehensive | premium. |
| | | | | access | coverage | Good choice if |
| | | | | | for chronic | minimizing |
| | | | | | conditions, | out-of-pocket |
| | | | | | robust | costs is a top |
| | | | | | wellness | priority. |
| | | | | | program | |
| 4 | “ValueHealth | $400 | $5,000 | Narrow | Lowest | Only |
| | Saver” | | | network, | premium, | recommended |
| | | | | limited | basic coverage | if budget is |
| | | | | specialist | for diabetes. | extremely |
| | | | | access | | limited and |
| | | | | | | individual is |
| | | | | | | willing to |
| | | | | | | accept high |
| | | | | | | out-of-pocket |
| | | | | | | costs and |
| | | | | | | limited |
| | | | | | | provider |
| | | | | | | choices. |

For example, the steps for generating the ranked list of insurance plans for each of the plurality personas based on the identified correlation and the association between the plurality of disorders using rank based matching algorithms is explained as follows: Initially, a list of insurance plans available from a payer comprising details on coverage options, benefits, and pricing are obtained. Further, the list of insurance plans are categorized based on a plurality of parameters comprising a type of coverage, a network availability, and a cost. Post categorizing, each of the plurality of personas is matched with the categorized list of insurance plans based on the essential, desirable or optional features identified using a matching algorithm. Post matching, a ranked list of insurance plans are generated for each of the plurality of personas, with the highest-ranking plans being those that best meet the specific requirements of the persona. The plurality of coverage types includes medical, dental, and vision. The plurality of critical or essential features includes high coverage limits and low out-of-pocket costs. The plurality of optional features includes wellness programs, telemedicine access and alternative medicine coverage.

At step 218 of the method 200, the one or more hardware processors 102 are configured by the programmed instructions to identify a plurality of common features associated with each of a plurality of top ranked insurance plans from among the ranked list of insurance plans for each of the plurality of personas. For example, some of the identified common features are cost of the plan, coverage by the plan, and the network of hospitals that the plan is applicable for and the like as shown in Table VII.

TABLE VII

| Feature | Specific | | Typical |
|---|---|---|---|
| Category | Feature | Description | Variations/Options |
| Cost- | Premium | Monthly payment to | Varies by plan type, |
| Sharing | | maintain coverage | coverage level, age, |
| | | | location |
| | Deductible | Amount you pay before | Varies widely, lower |
| | | insurance starts paying | deductible usually |
| | | | means higher |
| | | | premium |
| | Coinsurance | Percentage of costs | Commonly 10%, 20%, |
| | | you share with the | or 30% |
| | | insurer after meeting | |
| | | deductible | |
| | Copay | Fixed dollar amount | Varies by service |
| | | you pay for specific | type |
| | | services (e.g., doctor | |
| | | visit, prescription) | |
| | Out-of- | Maximum amount you'll | Set by the plan, an |
| | Pocket | pay out-of-pocket in a | important factor for |
| | Maximum | year | budgeting |
| Coverage | Medical | Covers doctor visits, | Different levels of |
| Types | | hospital stays, surgery, | coverage (e.g., |
| | | etc. | Bronze, Silver, Gold, |
| | | | Platinum) |
| | Prescription | Covers prescription | Formularies (lists of |
| | Drug | medications | covered drugs) vary |
| | | | by plan |
| | Dental | Covers dental checkups, | Often a separate |
| | | cleanings, fillings, etc. | plan or add-on |
| | Vision | Covers eye exams, | Often a separate |
| | | glasses, contacts | plan or add-on |
| Network | Preferred | Offers more flexibility | Wider network, |
| | Provider | to see out-of-network | typically higher |
| | Organization | doctors but at a higher | premiums |
| | (PPO) | cost | |
| | Health | Requires you to choose | Lower premiums, |
| | Maintenance | a primary care | more restrictive |
| | Organization | physician (PCP) and | network |
| | (HMO) | get referrals to | |
| | | specialists | |
| | Exclusive | Similar to HMOs but | Balances cost and |
| | Provider | generally don't require | network size |
| | Organization | referrals to specialists | |
| | (EPO) | within the network | |
| Other | Wellness | Incentives and | Increasingly |
| Features | Programs | resources for healthy | common in |
| | | living (e.g., gym | employer- |
| | | memberships, health | sponsored plans |
| | | coaching) | |
| | Telemedicine | Virtual doctor visits | Often covered, |
| | | | especially after the |
| | | | pandemic |
| | Mental | Therapy, counseling, | Parity with physical |
| | Health | and other mental health | health coverage is |
| | Coverage | services | required under the |
| | | | Affordable Care Act |
| | Maternity | Prenatal care, | Essential health |
| | Care | childbirth, and | benefit under the |
| | | postpartum care | Affordable Care Act |

At step 220 of the method 200, the one or more hardware processors 102 are configured by the programmed instructions to identify the plurality of coverage types (like medical, dental and vision) and benefits associated with the plurality of top ranked insurance plans based on the identified plurality of common features.

At step 222 of the method 200, the one or more hardware processors 102 is configured by the programmed instructions to determine a plurality of potential insurance plans from among the plurality of top ranked insurance, for each of the plurality of personas, with a plan variability less than a predefined threshold and best suiting overall needs of each persona based on the identified plurality of common features and the identified plurality of coverage types using a cosine similarity based matching technique. For example, Table VIII illustrates the plurality of potential insurance plans for an employer group ‘X’.

TABLE VIII

| | Persona 1 | | | | | Out-of- | |
|---|---|---|---|---|---|---|---|
| | (Young, | Persona 2 | Persona 3 | Premium | | Pocket | Key |
| Plan Name | Healthy) | (Families) | (Older) | (Monthly) | Deductible | Max | Features |
| HealthGuard | ✓ | ✓ | ✓ | $550 | $2,000 | $5,000 | Strong |
| Plus | (Rank 1) | (Rank 3) | (Rank 2) | | | | preventative |
| | | | | | | | care, good |
| | | | | | | | Rx coverage |
| MediCare | ✓ | ✓ | ✓ | $480 | $3,500 | $7,000 | Lower |
| Advantage | (Rank 2) | (Rank 1) | (Rank 3) | | | | premium, |
| | | | | | | | telehealth |
| | | | | | | | options |
| Blue Shield | ✓ | ✓ | ✓ | $620 | $1,500 | $4,000 | Comprehensive |
| Premier | Rank 3) | (Rank 2) | (Rank 1) | | | | coverage, |
| | | | | | | | excellent |
| | | | | | | | specialist |
| | | | | | | | access |

At step 224 of the method 200, the one or more hardware processors 102 is configured by the programmed instructions to compute real time pricing points for each of the plurality of potential insurance plans based on an associated plurality of historical claim frequency and historical 5 reimbursement pattern using a dynamic pricing model. For example, the formula for computing the real time pricing points is shown in equation (2).

$${C}_{\vert}^{\{} = {M}_{j} \pm 3 * {s}_{j} + {\sum }_{i} {p}_{i}^{t} {C}_{>}^{⊔} + {\sum }_{u} {p}_{u}^{e} {C}_{⊓}^{\vert \vert} \qquad ( 2 )$$

Here, Mⱼ and sⱼ are the mean and standard deviations of the claim amounts over the years except for those where the spikes happened,

$${p}_{i}^{t}$$

are the age and gender based prevalence rate calculated as above for the most probable diseases, based on a combination of the list of recurrent diseases (as shown in FIGS. 3A and 3B) and the market-basket analysis (as shown in FIG. 3C) in that age group

$${C}_{>}^{⊔}$$

are the related costs,

$${p}_{u}^{e}$$

is the age and gender based prevalence rate of the u^{th} disease that happened with the patient and caused a spike in claim, and

$${C}_{⊓}^{\vert \vert}$$

is the subsequent costs that can be calculated by subtracting the average claim amount of past years from that of the spike-year. Also, the cost is predicted not as a point-estimate but as an interval with the conventional 95% confidence, and hence used the mean±3*standard deviation convention. Finally, the mean predicted cost for that age group can be estimated as an empirical proposal

$${\sum }_{j} {C}_{j}^{f} .$$

The technique was applied on the age-group (45, 64) in the dataset and found the mean predicted cost as 24,654. The top ten prevalent diseases for the age group is also listed. Based on that information, the optimal insurance plan is recommended as explained in step 226.

At step 226 of the method 200, the one or more hardware processors 102 is configured by the programmed instructions to recommend an optimal insurance plan from among the plurality of potential insurance plans for each of the plurality personas based on the computed real time pricing points using a recommendation technique. An example optimal insurance plan is given in Table IX.

TABLE IX

| Feature | Description |
|---|---|
| Persona | Employees aged 45-64 with concerns about |
| Target | prediabetes, obesity, and family history of heart |
| | disease (as per the provided persona example). |
| Premium | $550/month (Example - determined by dynamic |
| | pricing model) |
| Deductible | $2,000 (Example) |
| Network | Large, includes preferred endocrinologists and |
| | nutritionists |
| Key Features | Strong preventative care coverage, Good diabetic |
| | medication coverage, Wellness program discounts |

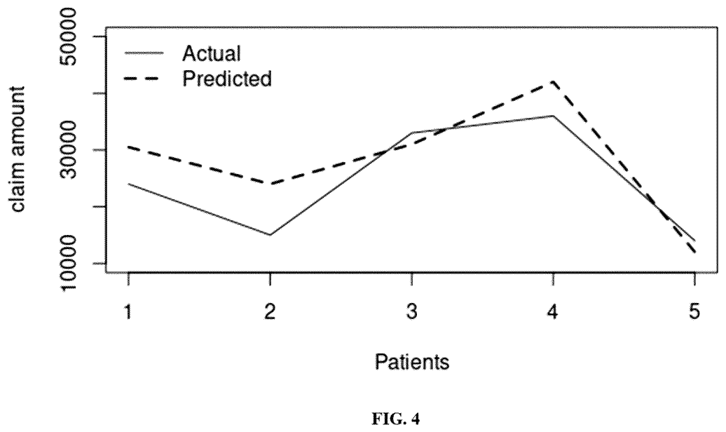

Experimentation: The present disclosure was experimented using publicly available datasets. Experimentation results show better performance of the present disclosure when compared to the conventional approaches. FIG. 4 indicates the prediction (based on age gender and disease 5 prevalence) of the claim amount over a period of years using the present disclosure. Cost Prediction is performed using Linear regression based on age and gender. Insurance plan recommendation is performed using a random plan assignment. Pricing is computed using traditional actuarial methods based on age/gender bands.

Considering an employer group with three personas:
Persona 1: Young, healthy individuals (25-35 years old). Low historical claims, prioritize preventive care.
Persona 2: Families with young children (35-45 years old). Moderate claims, primarily related to pediatric care.
Persona 3: Older individuals (55-65 years old). High historical claims, some with chronic conditions.

An example result of experimentation for the above personas is shown in Table X.

TABLE X

| | | | | Comparison |
|---|---|---|---|---|
| | | Performance | | with |
| Experiment | Dataset | Metric | Results | Baseline |
| 1. Cost | Synthetic | Root Mean | RMSE of | 20% reduction |
| Prediction | commercial | Squared Error | $2,500 | in RMSE |
| Accuracy | payer claims | (RMSE) | | compared to a |
| | data (10,000 | | | baseline |
| | beneficiaries, | | | model using |
| | 5 years of | | | only age and |
| | claims history) | | | gender |
| 2. Persona- | Same as | Plan | 85% of | 15% increase |
| Based Plan | Experiment 1, | Satisfaction | employees | in satisfaction |
| Recommendation | plus employee | (surveyed) | satisfied with | compared to |
| | survey data | | recommended | randomly |
| | (500 respondents) | | plan | assigned plans |
| 3. Impact of | Same as | Payer | 10% increase | 5% increase |
| Dynamic Pricing | Experiment 1 | Profitability | in payer | compared to |
| | | (simulated) | profitability | traditional |
| | | | within the | static pricing |
| | | | first 3 years | models |
| 4. Scalability | Varied dataset | Computational | Linear increase | Demonstrates |
| | size (10,000 | Time | in computation | feasibility for |
| | to 100,000 | | time with | large employer |
| | beneficiaries) | | data size | groups |

Dynamic Pricing: Leverage historical insurance claims, disease prevalence data, and market basket analysis (identifying correlations between conditions like prediabetes and psychological issues) to calculate personalized premiums.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of the present disclosure herein address the unresolved problem of cost of care prediction based dynamic insurance plan recommendation and pricing. The present disclosure provides group insurance recommendation where individual and member and their family histories are not available with the insurance provider. Further, the present disclosure provides a dynamic recommendation based on demography and prevalence, which does not require explicit rules. This is important because treatment protocol and burden change over time. Furthermore, the present disclosure not only consider pre-existing conditions but also propensity for correlated diseases using market basket analysis.

Further, the present disclosure offers several advantages. The first one is personalization. By creating detailed member personas and matching them with appropriate plans, the system provides personalized insurance options tailored to the specific needs of employees. The system is efficient in the sense that it reduces the time required to onboard employer groups by streamlining the setup process and plan configuration. Also, using a dynamic pricing model, the system allows for the adjustment of pricing based on real-time data, ensuring that insurance costs are aligned with the actual risk and resource consumption of the employee group.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means, and software means. The method embodiments described herein could be implemented in hardware and software. The device may also include software means. Alternatively, the embodiments may be implemented on different hardware devices, e.g., using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method comprising:
receiving, by one or more hardware processors, an input data pertaining to a plurality of beneficiaries, wherein the input data comprises a demographic data, a historical claims data, an insurance plan survey, a cost per beneficiary, a total claim amount vs time, disease severity, and utilization patterns;
generating, by the one or more hardware processors, a clean data by performing data cleaning and data validation on the input data, wherein the data cleaning and the data validation process comprises identifying and filling missing values, identifying and correcting inconsistent data, and datatype conversion;
segmenting, by the one or more hardware processors, the plurality of beneficiaries into a plurality of groups based on the clean data, wherein the plurality of groups comprises a disease prevalence, an age vs disease propensity, and a preventive healthcare data;
generating, by the one or more hardware processors, a plurality of personas with distinct profiles based on the segmented plurality of groups, wherein each of the plurality of personas comprises a plurality of coverage types, a plurality of critical features, and a plurality of additional features;
computing, by the one or more hardware processors, a plurality of risk scores for each of the plurality of personas based on a cost of care associated with each of the plurality of personas, a healthcare utilization frequency associated with each of the plurality of personas, and an associated disease risk, using a weight based risk computation technique;
categorizing, by the one or more hardware processors, the plurality of personas into a plurality of risk tiers based on the computed plurality of risk scores, wherein the plurality of risk tiers comprises low risk, medium risk and high risk groups based on associated range of risk thresholds;
identifying, by the one or more hardware processors, a correlation and an association between a plurality of disorders to have simultaneous occurrence in the portfolio of each of the plurality of beneficiaries based on the categorized plurality of personas using a market basket analysis;
generating, by the one or more hardware processors, a ranked list of insurance plans for each of the plurality personas based on the identified correlation and the association between the plurality of disorders, using one or more rank based matching algorithms;
identifying, by the one or more hardware processors, a plurality of common features associated with each of a plurality of top ranked insurance plans from among the ranked list of insurance plans for each of the plurality of personas;
identifying, by the one or more hardware processors, the plurality of coverage types and benefits associated with the plurality of top ranked insurance plans based on the identified plurality of common features;
determining, by the one or more hardware processors, a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique;
computing, by the one or more hardware processors, real time pricing points for each of the plurality of potential insurance plans based on an associated plurality of historical claim frequency and a historical reimbursement pattern, using a dynamic pricing model; and
recommending, by the one or more hardware processors, an optimal insurance plan from among the plurality of potential insurance plans for each of the plurality personas based on the computed real time pricing points, using a recommendation technique.

2. The processor implemented method as claimed in claim 1, wherein the cost per beneficiary comprises costs of drug, physician, and care.

3. The processor implemented method as claimed in claim 1, wherein the historical claims data comprises medical treatments, prescription usage, specialty pharmaceuticals, and one or more other health-related expenses.

4. The processor implemented method as claimed in claim 1, wherein the plurality of coverage types comprise medical, dental, and vision, wherein the plurality of critical features comprise high coverage limits and low out-of-pocket costs, and wherein the plurality of additional features comprise wellness programs, telemedicine access and alternative medicine coverage.

5. The processor implemented method as claimed in claim 1, wherein the insurance plan survey comprises types of coverage, desired features, and satisfaction with current plans.

6. The processor implemented method as claimed in claim 1, wherein steps for generating the ranked list of insurance plans for each of the plurality personas based on the identified correlation and the association between the plurality of disorders using the one or more rank based matching algorithms comprises:
obtaining a list of insurance plans available from a payer, comprising details on coverage options, benefits, and pricing;
categorizing the list of insurance plans based on a plurality of parameters comprising a type of coverage, a network availability, and cost, to generate a categorized list of insurance plans;
matching each of the plurality of personas with the categorized list of insurance plans based on the essential, desirable, and optional features identified using the one or more matching algorithms; and
generating the ranked list of insurance plans for each of the plurality of personas, wherein in the ranked list of insurance plans, plans that meet the specific requirements of the persona are assigned highest ranks.

7. A system comprising:
at least one memory storing programmed instructions; one or more Input/Output (I/O) interfaces; and one or more hardware processors operatively coupled to the at least one memory, wherein the one or more hardware processors are configured by the programmed instructions to:
receive an input data pertaining to a plurality of beneficiaries, wherein the input data comprises a demographic data, a historical claims data, an insurance plan survey, a cost per beneficiary, a total claim amount vs time, disease severity, and utilization patterns;
generate a clean data by performing data cleaning and data validation on the input data, wherein the data cleaning and the data validation process comprises identifying and filling missing values, identifying and correcting inconsistent data, and datatype conversion;
segment the plurality of beneficiaries into a plurality of groups based on the clean data, wherein the plurality of groups comprises a disease prevalence, an age vs disease propensity, and a preventive healthcare data;
generate a plurality of personas with distinct profiles based on the segmented plurality of groups, wherein each of the plurality of personas comprises a plurality of coverage types, a plurality of critical features, and a plurality of additional features;
compute a plurality of risk scores for each of the plurality of personas based on a cost of care associated with each of the plurality of personas, a healthcare utilization frequency associated with each of the plurality of personas, and an associated disease risk, using a weight based risk computation technique;
categorize the plurality of personas into a plurality of risk tiers based on the computed plurality of risk scores, wherein the plurality of risk tiers comprises low risk, medium risk and high risk groups based on associated range of risk thresholds;
identify a correlation and an association between a plurality of disorders to have simultaneous occurrence in the portfolio of each of the plurality of beneficiaries based on the categorized plurality of personas using a market basket analysis;
generate a ranked list of insurance plans for each of the plurality personas based on the identified correlation and the association between the plurality of disorders, using one or more rank based matching algorithms;
identify a plurality of common features associated with each of a plurality of top ranked insurance plans from among the ranked list of insurance plans for each of the plurality of personas;
identify the plurality of coverage types and benefits associated with the plurality of top ranked insurance plans based on the identified plurality of common features;
determine a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique;
compute real time pricing points for each of the plurality of potential insurance plans based on an associated plurality of historical claim frequency and a historical reimbursement pattern, using a dynamic pricing model; and
recommend an optimal insurance plan from among the plurality of potential insurance plans for each of the plurality personas based on the computed real time pricing points, using a recommendation technique.

8. The system as claimed in claim 7, wherein the cost per beneficiary comprises costs of drug, physician, and care.

9. The system as claimed in claim 7, wherein the historical claims data comprises medical treatments, prescription usage, specialty pharmaceuticals, and one or more other health-related expenses.

10. The system as claimed in claim 7, wherein the plurality of coverage types comprise medical, dental, and vision, wherein the plurality of critical features comprise high coverage limits and low out-of-pocket costs, and wherein the plurality of additional features comprise wellness programs, telemedicine access and alternative medicine coverage.

11. The system as claimed in claim 7, wherein the insurance plan survey comprises types of coverage, desired features, and satisfaction with current plans.

12. The system as claimed in claim 7, wherein steps for generating the ranked list of insurance plans for each of the plurality personas based on the identified correlation and the association between the plurality of disorders using the one or more rank based matching algorithms comprises:
obtaining a list of insurance plans available from a payer, comprising details on coverage options, benefits, and pricing;
categorizing the list of insurance plans based on a plurality of parameters comprising a type of coverage, a network availability, and cost, to generate a categorized list of insurance plans;
matching each of the plurality of personas with the categorized list of insurance plans based on the essential, desirable, and optional features identified using the one or more matching algorithms; and
generating the ranked list of insurance plans for each of the plurality of personas, wherein in the ranked list of insurance plans, plans that meet the specific requirements of the persona are assigned highest ranks.

13. One or more non-transitory machine-readable information storage mediums comprising one or more instructions which when executed by one or more hardware processors cause:
receiving an input data pertaining to a plurality of beneficiaries, wherein the input data comprises a demographic data, a historical claims data, an insurance plan survey, a cost per beneficiary, a total claim amount vs time, disease severity, and utilization patterns;
generating a clean data by performing data cleaning and data validation on the input data, wherein the data cleaning and the data validation process comprises identifying and filling missing values, identifying and correcting inconsistent data, and datatype conversion;
segmenting the plurality of beneficiaries into a plurality of groups based on the clean data, wherein the plurality of groups comprises a disease prevalence, an age vs disease propensity, and a preventive healthcare data;
generating a plurality of personas with distinct profiles based on the segmented plurality of groups, wherein each of the plurality of personas comprises a plurality of coverage types, a plurality of critical features, and a plurality of additional features;
computing a plurality of risk scores for each of the plurality of personas based on a cost of care associated with each of the plurality of personas, a healthcare utilization frequency associated with each of the plurality of personas, and an associated disease risk, using a weight based risk computation technique;
categorizing the plurality of personas into a plurality of risk tiers based on the computed plurality of risk scores, wherein the plurality of risk tiers comprises low risk, medium risk and high risk groups based on associated range of risk thresholds;
identifying a correlation and an association between a plurality of disorders to have simultaneous occurrence in the portfolio of each of the plurality of beneficiaries based on the categorized plurality of personas using a market basket analysis;
generating a ranked list of insurance plans for each of the plurality personas based on the identified correlation and the association between the plurality of disorders, using one or more rank based matching algorithms;
identifying a plurality of common features associated with each of a plurality of top ranked insurance plans from among the ranked list of insurance plans for each of the plurality of personas;
identifying the plurality of coverage types and benefits associated with the plurality of top ranked insurance plans based on the identified plurality of common features;
determining a plurality of potential insurance plans from among the plurality of top ranked insurance plans, for each of the plurality of personas, with (i) a plan variability less than a predefined threshold and (ii) suiting a plurality of overall needs of each persona based on the identified plurality of common features and the identified plurality of coverage types, using a cosine similarity based matching technique;
computing real time pricing points for each of the plurality of potential insurance plans based on an associated plurality of historical claim frequency and a historical reimbursement pattern, using a dynamic pricing model; and
recommending an optimal insurance plan from among the plurality of potential insurance plans for each of the plurality personas based on the computed real time pricing points, using a recommendation technique.

14. The one or more non-transitory machine-readable information storage mediums of claim 13, wherein the cost per beneficiary comprises costs of drug, physician, and care.

15. The one or more non-transitory machine-readable information storage mediums of claim 13, wherein the historical claims data comprises medical treatments, prescription usage, specialty pharmaceuticals, and one or more other health-related expenses.

16. The one or more non-transitory machine-readable information storage mediums of claim 13, wherein the plurality of coverage types comprise medical, dental, and vision, wherein the plurality of critical features comprise high coverage limits and low out-of-pocket costs, and wherein the plurality of additional features comprise wellness programs, telemedicine access and alternative medicine coverage.

17. The one or more non-transitory machine-readable information storage mediums of claim 13, wherein the insurance plan survey comprises types of coverage, desired features, and satisfaction with current plans.

18. The one or more non-transitory machine-readable information storage mediums of claim 13, wherein steps for generating the ranked list of insurance plans for each of the plurality personas based on the identified correlation and the association between the plurality of disorders using the one or more rank based matching algorithms comprises:
obtaining a list of insurance plans available from a payer, comprising details on coverage options, benefits, and pricing;
categorizing the list of insurance plans based on a plurality of parameters comprising a type of coverage, a network availability, and cost, to generate a categorized list of insurance plans;
matching each of the plurality of personas with the categorized list of insurance plans based on the essential, desirable, and optional features identified using the one or more matching algorithms; and
generating the ranked list of insurance plans for each of the plurality of personas, wherein in the ranked list of insurance plans, plans that meet the specific requirements of the persona are assigned highest ranks.
